(19) United States
(12) Patent Application Publication
(10) Pub. No.: US 2006/0252293 A1
(43) Pub. Date: Nov. 9, 2006

(54) Modular plastic well with induction-melting assembly

(76) Inventors: Andrea Ticci, Imola BO (IT); Nicola Achille Giani, Busto Arsizio VA (IT); Marco Genoni, Arese MI (IT)

Correspondence Address: JACOBSON HOLMAN PLLC, 400 SEVENTH STREET N.W., SUITE 600, WASHINGTON, DC, 20004, US

(21) Appl. No.: 11/411,157

(22) Filed: Apr. 26, 2006

(30) Foreign Application Priority Data
Apr. 26, 2005 (IT) MI2005U 000143

(51) Int. Cl. H01R 4/60

(52) U.S. Cl. 439/212

(57) ABSTRACT

A plastic well comprises a box-shaped base part from which projects upward a vertical access duct. The base part and the access duct are made of separate parts and are connected together by means of a connector item constituting a cover of the base part and having a central hole to which is connected the lower end of the access duct. The connector item and the base part have mutually facing surfaces between which there is a first welding bead for induction melting allowing rapid jointing in place of the connector item onto the base part. Advantageously the connector item is also in a piece separate from the access duct, connector item and access duct having mutually facing surfaces between which there is a second welding bead for welding by induction melting allowing fast jointing in place of the access duct on the connector item.

### BACKGROUND OF THE INVENTION

1. Field of the Invention

This invention relates to a well of the type for cisterns or similar made up of parts assemblable by means of induction melting.

The general purpose of this invention is to make available a plastic well occupying little storage and transport space and being easy and fast to assemble.

### SUMMARY OF THE INVENTION

In view of this purpose it was sought to provide in accordance with this invention a plastic well comprising a box-shaped base part from which projects upward a vertical access duct and characterized in that the base part and the access duct are made of separate parts and are connected together by means of a connector item constituting a cover of the base part and having a central hole to which is connected the bottom end of the access duct with the connector item and the base part having mutually facing surfaces between which there is a first welding bead for induction melting allowing rapid jointing in place of the connector item on the base part.

### BRIEF DESCRIPTION OF THE DRAWINGS

To clarify the explanation of the innovative principles of this invention and its advantages compared with the prior art there is described below with the aid of the annexed drawings a possible embodiment thereof by way of non-limiting example applying said principles. In the drawings:

FIG. 1 shows a perspective view of a disassembled well realized in accordance with this invention,

FIG. 2 shows a partially cross-sectioned side elevation view of the well of FIG. 1 in the condition folded for hauling, and

FIG. 3 shows a partially cross-section view of the well of FIG. 1 in assembled condition.

### DETAILED DESCRIPTION OF THE INVENTION

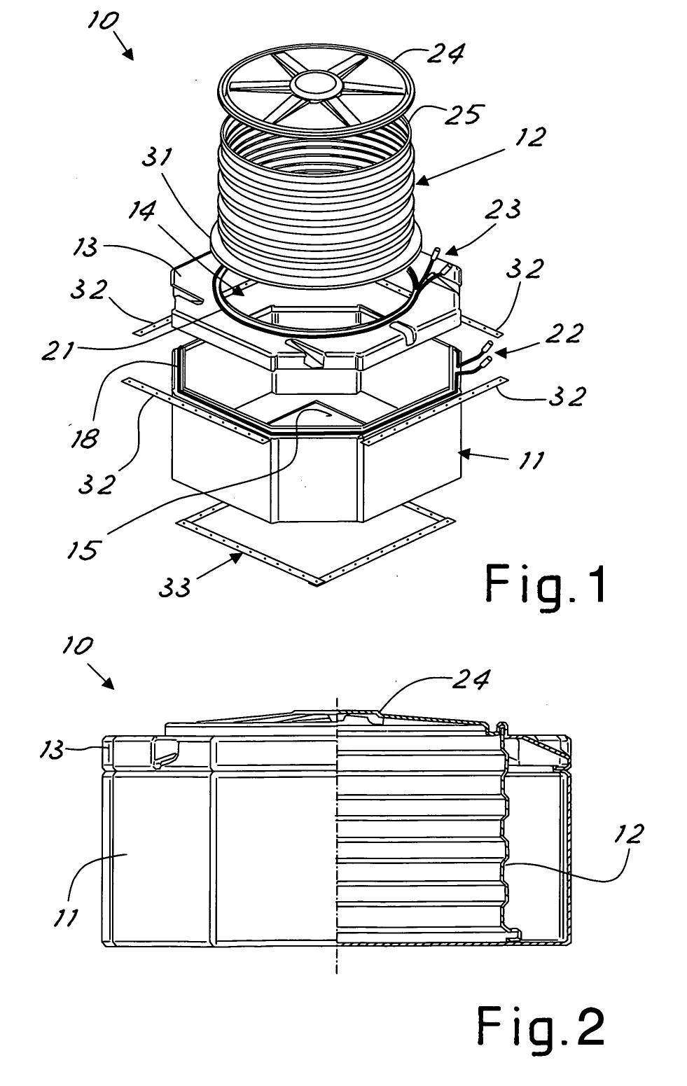

With reference to the figures, FIG. 1 shows a well designated as a whole by reference number 10 and realized of plastic material in accordance with the principles of this invention and mainly designed to be installed on buried cisterns. A preferred material is polyethylene.

The well 10 comprises a box-shaped base part 11 from which projects upward a vertical access duct 12 which realizes the mouth of the well and is advantageously closed by a cover 24. The base part realizes the so-called man-hole and is usually designed to receive hydraulic connectors, valves et cetera. The base part has a bottom in which advantageously a hole 15 opens or can open for passage towards the connector of the cistern as clarified below.

The base item 11 and the access duct 12 are made up of separate parts and are connected together by means of a connector item 13 that constitutes the cover of the base part and has a central hole 14 to which is connected the lower end of the access duct.

The connector item 13 and the base part 11 have mutual facing surfaces 16, 17 between which there is a first welding bead for induction melting 18. In the realization shown the welding bead is advantageously constrained to the peripheral edge of the base part.

In the preferred realization shown the connector item 13 is also a part separated from the access duct 12 and connector item and access duct have mutually facing surfaces 19, 20 between which there is a second welding bead for induction melting 21. Advantageously the bead is constrained to the connector item.

Thus it is obtained that from the disassembled condition one can pass rapidly to the well with the parts assembled by superimposing the parts and welding through connection of the beads to known electrical power supply equipment for the thermofusion. The beads 18, 21 are the generally known type made of an thermofusible material designed for gluing of the chosen materials to the corresponding items of the well and with internal heating conducting wires. For example, with a polyethylene well, the thermofusible material can advantageously be of polyethylene also.

For the electrical connection, the beads have ends 22, 23 ending with electrical contact plugs on the outside of the well.

As may be seen in FIG. 2, part of the base 11 and access duct 12 are advantageously sized in such a manner that in a condition disassembled for transport the base part realizes a box containing the access duct.

In particular, base item, connector item, cover and duct can be sized in such a manner that in disassembled transport condition the cover 24 becomes a closure of the round hole 14 of the connector item for closing therewith the base part with the access duct within.

As may be seen in FIG. 2, the disassembled well arranged in transport condition becomes very compact and occupies minimum space and is also easy to stack, box and pack alone or with other similar items.

As another advantageous characteristic, quite visible in FIG. 2, the access duct 12 can have its upper end 25 of a diameter slightly smaller than the hole 14 in the connector item and total height such that (in the specific case virtually equal to the height of the base body) in a disassembled transport condition the access duct can be received in the base part, rested vertically on the bottom of the base part, and have its upper end 25 received with small side play in the hole 14 on the connector item, placed to close the base part. The duct is kept relatively steady in the base body in this manner.

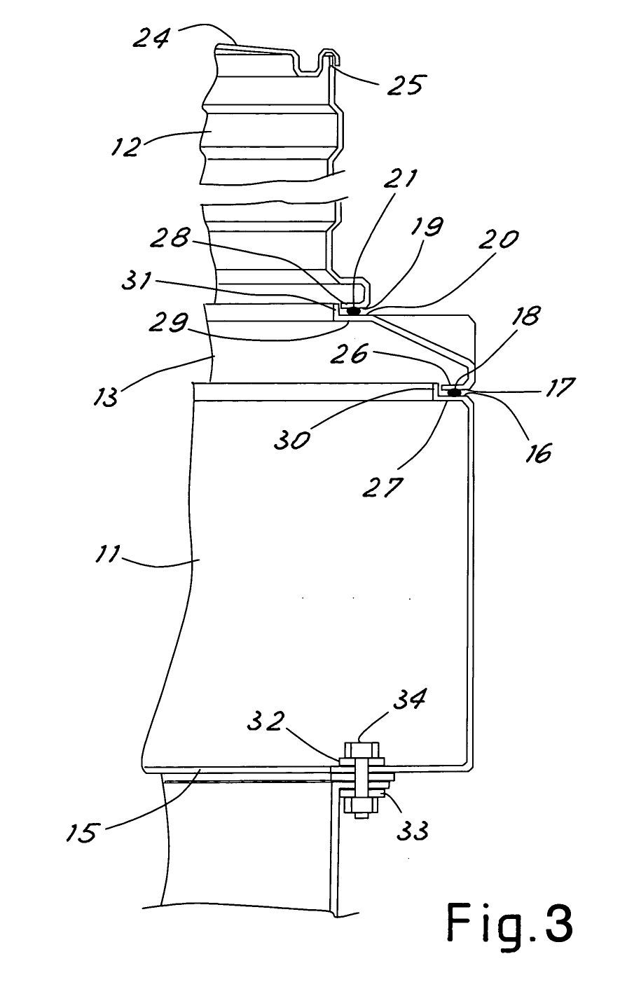

As may be seen in greater detail in FIG. 3, to realize the facing surfaces between the connector item ant the base part, the connector item can advantageously have a radial peripheral edge 26 below (preferably directed inward) and the base part can have an upper mouth surrounded by a corresponding radial surface 27. The welding bead 18 can be constrained (for example, by means of appropriate jointing or gluing points) onto the edge 26 or onto the radial surface 27. Advantageously, it can be on the surface 27 as shown in FIG. 1.

Similarly, to realize the facing surfaces between duct 12 and the connector item 13 the duct has its lower end with a radial peripheral edge 28 (preferably inwardly) and the hole in the connector item is surrounded by a corresponding radial surface 29.

In both cases the corresponding welding bead 18 or 21 can be constrained (for example, by appropriate jointing or gluing points) on one of the two surfaces to keep it in position before the induction melting. In the realization shown, it was preferred to have the bead 21 on the surface 29 and the bead 18 on the surface 27.

Again advantageously, the upper edge of the base part or the lower edge of the connector item has an end edge bent to be inserted with little side play in the other item when coupled and constitute a centering guide upon mutual coupling. In the solution shown, the bent edge, designated by reference number 30, projects upward from the base part to be inserted in the connector item opposite the edge 26 of the latter bent inward.

In the same manner, it is advantageous that the central hole 14 of the connector item or the lower end of the access duct 12 be fitted with an edge bent to be inserted with little side play in the other item with which it couples so as to constitute a centering guide for mutual coupling. In the solution shown, the bent edge, designated by reference number 31, projects upward from the connector item to be inserted in the duct 12 opposite the edge 28 of the latter bent inward.

Some items 32, 33, 34 are shown disassembled in FIG. 1 and assembled in FIG. 3 for constraint of the lower face of the well base item to a cistern. The hole 15 in the lower face of the base body can be made at the time of installation by cutting the bottom of the base item, or the base item can be supplied already pierced. In the realization shown, the constraining items comprise strengthening metallic frames which are to be arranged on the two faces of the bottom of the base part 11 near the edge of the hole 15, and through screws for connection with an appropriate flange on the cistern. A peripheral gasket can also be provided.

It is now clear that the preset purposes have been achieved by making available a modular well having reduced space occupied during storage and transportation and characteristics allowing rapid connection in place of the component parts to obtain a complete well with a stout structure and without maintenance in the connections. In addition, the practicality of being able to first install the base part on the cistern and, aided by the broad access, assemble all the necessary hydraulic components inside said base part is clear, and even the side walls can be pierced for entrance and exit of tubing. After the assembly operations in the base part, it is possible to assemble rapidly on the base part the connector item and the access duct to complete the well.

Naturally the above description of an embodiment applying the innovative principles of this invention is given by way of non-limiting example of said principles within the scope of the exclusive right claimed here. For example, the proportions and dimensions of the various parts can vary in accordance with the specific practical requirements.

What is claimed is:

1. Plastic well comprising a box-shaped base part from which projects upward a vertical access duct and characterized in that the base part and the access duct are made of separate parts and are connected together by means of a connector item constituting a cover of the base part and having a central hole to which is connected the lower end of the access duct with the connector item and the base part having mutually facing surfaces between which there is a first welding bead for induction melting allowing rapid connection in place of the connector item onto the base part.

2. Well in accordance with claim 1 characterized in that the connector item is also a part separate from the access duct with the connector item and the access duct having mutually facing surfaces between which there is a second induction melting welding bead allowing fast connection in place of the access duct onto the connector item.

3. Well in accordance with claim 1 characterized in that the base part and the access duct are sized in such a manner that, in a disassembled condition for transport, the base part constitutes the box containing the access duct.

4. Well in accordance with claim 1 characterized in that the access duct has a cover for top closure.

5. Well in accordance with claim 4 characterized in that the base item, connector item, cover and duct are sized in such a manner that in a disassembled transport condition the top closing cover of the access duct constitutes a closure of the round hole of the connector item for closing therewith the base part with the access duct within.

6. Well in accordance with claim 3 characterized in that the access duct has its upper end of a slightly smaller diameter than said hole in the connector item and a height such that in a disassembled transport condition the access duct can be received in the base part rested vertically on the bottom of the base part and have the top end received with little side play in said hole in the connector item positioned to close the base part.

7. Well in accordance with claim 1 characterized in that to realize said facing surfaces between the connector item and the base part the connector item has at the bottom a radial peripheral edge and the base part has an upper mouth surrounded by a corresponding radial surface with the first welding bead being arranged either on said edge or on the radial surface.

8. Well in accordance with claim 2 characterized in that the to realize said facing surfaces between the duct and the connector item the duct has its lower end with a radial peripheral edge and the hole in the connector item is surrounded by a corresponding radial surface with the second welding bead being arranged either on said edge or on the radial surface.

9. Well in accordance with claim 1 characterized in that either the top edge of the base part or the bottom edge of the connector item has an edge bent upward to be inserted therein with slight side play and constitute a centering guide for mutual coupling.

10. Well in accordance with claim 2 characterized in that either said central hole or the bottom end of the access duct has an edge bent towards the other be inserted therein with slight side play and constitute a guide for centering upon mutual coupling.

11. Well in accordance with claim 1 characterized in that the base part, the connector and the duct are made of polyethylene.

12. Well in accordance with claim 1 characterized in that the first welding bead is made of polyethylene with electric heating wires immersed therein and ending at opposite ends with electrical contact plugs for connection to electrical power supply equipment for the thermofusion.

13. Well in accordance with claim 2 characterized in that the second welding bead is made of polyethylene with electric heating wires immersed therein and ending at opposite ends with electrical contact plugs for connection to electrical power supply equipment for the thermofusion.

14. Well in accordance with claim 1 characterized in that on the lower face of the base part there are items for constraint of the well to a cistern.
